(19) United States
(12) Patent Application Publication
(10) Pub. No.: US 2003/0011748 A1
(43) Pub. Date: Jan. 16, 2003

(54) Apparatus and method for scanning film images

(76) Inventor: Nigel Stephen Varian, Marina del Rey, CA (US)

Correspondence Address: William E. Thomson, Jr., McCutchen, Doyle, Brown & Enersen, LLP, 18th Floor, Three Embarcadero Center, San Francisco, CA, 94111, US

(21) Appl. No.: 09/903,914

(22) Filed: Jul. 11, 2001

(51) Int. Cl. G03C 1/00; G03B 1/00

(52) U.S. Cl. 352/244

(57) ABSTRACT

The present invention provides an apparatus and method for producing high digital resolution images. Specifically, the present invention provides a film scanner and method for producing motion picture film images with a high digital resolution. In a particular embodiment, the present invention provides a film scanner, comprising: (a) a first image sensor for scanning an image from a film; (b) a second image sensor for capturing an image of a marker along the length of said film; (c) a means for processing a captured marker image; and (d) a means for synchronizing the first image sensor with the second image sensor. The method for scanning an image from a film comprises: (a) scanning an image from the film with a first image sensor; (b) capturing an image of a marker along the film with a second image sensor; (c) processing the captured marker image; and (d) synchronizing the first image sensor with the second image sensor.

### FIELD OF THE INVENTION

The present invention relates generally to the field of film scanners, particularly for scanning motion picture films.

### BACKGROUND OF THE INVENTION

Scanners for motion picture films have been known for many years. Initially, they were used to scan film to video. Recently, their use has been expanded to include scanning to high-definition digital formats suitable for computer manipulation. Computer-generated artwork and special effects are added to these high definition images, which are then recorded back to film and cut into the movie to create the fantastic imagery of modem films. The ever increasing volume of effects in movies today is pushing the industry towards scanning the entire camera footage and then performing the complete post-production process digitally, resulting in a high15 definition digital master which is then recorded back to the negative. This negative is then used to generate the high volume of prints for cinema release.

Key parameters in scanning films are resolution (i.e., sharpness), color fidelity, and image steadiness (i.e., registration). Film scanners fall into two main categories: sequential fall frame image capture systems, and continuous motion scanners. The first category of scanners uses a digital camera to take a picture of a stationary film image which is registered on precision pins. After the exposure the film is advanced a frame, and the operation repeated. These scanners produce good results but are generally slow.

Continuous motion scanners, the second category of film scanner, further divide into two categories: flying spot scanners, and line array scanners. The flying spot uses CRT (cathode ray tube) technology where the film is scanned by a flying spot of light generated by a CRT. The spot sweeps across the film and then flies back to start another sweep by which time the film has advanced a distance equivalent to the spot size. The signal received by the photo receptor is digitized and stored in memory where the image is built up as the film advances.

Line array scanners typically use CCD (charge coupled devices) technology in which a line of photo-sensitive elements captures data. The film is illuminated by a light source and the sensors build up an image of a line over a finite integration period. At regular intervals governed by the advance of the film, the data gathered by the line of sensors are dumped into memory and the next line acquired.

Both of these continuous systems require an accurate film transport system and need to synchronize the image sensors with the film motion. Motion picture films contain perforations which are fundamental to the technology of image capture in the camera and projection in the cinema. A sprocket or pin mechanism engages the perforations on all motion picture scanners. By attaching an electronic encoder to this sprocket or pin mechanism, the motion of the film can be translated to a signal which measures that motion. Thus, the sprocket/encoder assembly provides synchronization between the film and the image acquisition line array camera.

However, systems relying on sprocket mechanisms have limitations. For the sprocket to accurately measure the film motion, the teeth must fit the perforations precisely or it is possible for the film to take different positions on the sprocket. Sprocket tooth shape and mechanical tolerances are critical in generating a smooth motion free of vibration. Film vibration at the scanner gate will result in poor image quality. Moreover, film is not dimensionally stable and can shrink significantly with age.

Attempts have been described in U.S. Pat. No. 5,266,979 to combine edge guidance and full fitting pins with a sprocket wheel arrangement. However, this system over constrains the film as it passes through a film gate for scanning, which can result in film flatness or image distortion problems. Further, in any sprocket wheel arrangement, since the same pins do not contact each frame, a large emphasis is placed upon the quality of manufacturing processes for sprocket wheels.

Pure pin registration systems utilize both a full fitting big pin to engage perforations along one side of the film, and a partial fitting little pin to engage perforations along the other edge of the film, to exactly constrain the film in the x and y directions, and to prevent rotation of the film. The same pins are used to register each frame. When properly designed and maintained, these systems provide the best duplication of camera pin registration.

However, there are disadvantages to the use of mechanical pin registration. In general, such systems are intermittent motion systems with lower throughput. Also, the design, construction, and maintenance of the registration mechanism and the pins are expensive. In addition, the complexity and cost of the subsystems surrounding a pin registered film scanning gate is relatively high. Furthermore, the risk of perforation damage is a constant concern, since film age and means of storage will effect the dimensions and elasticity of the film. Thus, the risk of damage to archived films increases in a pin registered system. As a result, pin registered systems are not used in high throughput motion picture film scanning systems.

Non-contact perforation detection systems avoid the risk of film damage, and can run at high speed. In addition, non-contact perforation detection systems are inexpensive and can be easily maintained. Several non-contact perforation detection systems have been described, for example, in U.S. Pat. No. 5,107,127, the disclosure of which is herein incorporated by reference. U.S. Pat. No. 4,319,280 discloses a film scanner with an encoder wheel which is remote from the actual scanning position of the film. However, these non-contact perforation detection systems do not appreciate problems associated with dimensional variations along the length of a film being scanned. Thus, there remains a need for scanners that provide stable and accurate high-resolution digital images, and are simple to use.

### SUMMARY OF THE INVENTION

It is an object of the present invention to provide an apparatus and method for producing high digital resolution images. Specifically, the present invention provides an apparatus and method for producing motion film images with a digital resolution that is higher than the required image scans.

The present invention provides a film scanner, comprising: (a) a first image sensor for scanning an image from a film, thereby producing a scanned image; (b) a second image sensor for capturing an image of a marker along the length of said film, thereby producing a captured marker image; (c) a means for processing a captured marker image; and (d) a means for synchronizing the first image sensor with the second image sensor. In one embodiment, the first image sensor, the second image sensor, or both, may comprise a charge coupled device (CCD) line array scanner. The second image sensor may be placed at an orthogonal orientation to said first image sensor or placed at the same location as the first image sensor. The marker along the length of the film may comprise a perforation, a frame line between a first and a second image on said film, or an index marker.

In another embodiment, the means for processing the captured marker image comprises: (a) a means for counting horizontal divisions in said captured marker image that differ from a threshold light level; (b) a means for storing horizontal divisions at an actual light level; (c) a means for accounting an offset between the first image sensor and the second image sensor; and (d) a means for comparing horizontal divisions at the actual light level with the horizontal divisions at the threshold light level.

The means for synchronizing the first image sensor with the second image sensor may comprise: (a) a means for transmitting the position of horizontal divisions in the captured marker image to the first image sensor; and (b) a means for triggering the first image sensor when the horizontal divisions in the captured marker image reach a certain position within the second image sensor.

In addition, the first image sensor may comprise a photo-sensitive element, which in turn may comprise a pixel. In a particular embodiment, the second image sensor is configured such that about four pixels of CCD correspond to one line of the scanned image.

The present invention also provides a method for scanning an image from a film, comprising: (a) scanning an image from said film with a first image sensor, to produce a scanned image; (b) capturing an image of a marker along the film with a second image sensor, to produce a captured marker image; (c) processing the captured marker image; and (d) synchronizing the first image sensor with the second image sensor. In one embodiment, the first image sensor, the second image sensor, or both may comprise a charge coupled device (CCD) line array scanner. The second image sensor may be placed at an orthogonal orientation to said first image sensor or placed at the same location as the first image sensor. The marker along the film may comprise a perforation, a registration mark opposite each image on said film, a frame line between a first and a second image on said film, or an index marker.

In another embodiment, the processing step further comprises the steps of: (a) calibrating the second image sensor with a threshold light level; (b) counting the number of horizontal divisions in the captured marker image that differ from said threshold light level; (c) storing horizontal divisions at an actual light level; (d) accounting for an offset between the first image sensor and the second image sensor; and (e) comparing the horizontal divisions at the actual light level with horizontal divisions at the threshold light level.

In yet another embodiment, the synchronizing step further comprises: (a) transmitting the position of horizontal divisions in the captured marker image to the first image sensor; and (b) triggering the first image sensor when the horizontal divisions in the captured marker image reach a certain position within said image sensor.

This invention can also be used to digitize microfiche or microfilm. In this embodiment, images such as banking records, checks, deposit slips, newspapers and other data is recorded on reels of 16 mm wide film. Each record is identified with a registration mark on the edge of the film opposite each document, which would be scanned as an alternative to scanning perforations.

### BRIEF DESCRIPTION OF THE DRAWINGS

FIG. 1 is an explanatory view showing image and Photographic Image Registration (PIR) camera orientation and resolutions, according to one embodiment of the present invention.

FIG. 2 is an explanatory view showing a view of a section of the moving film and perforation against the fixed PIR line array CCD camera, according to one embodiment of the present invention.

FIG. 3 is an explanatory view of the Photographic hnage Stabilization system, according to one embodiment of the present invention.

FIG. 4 is a block diagram showing the PIR system over a view of the film, according to one embodiment of the present invention.

### DETAILED DESCRIPTION OF THE INVENTION

The present invention provides apparatus and methods for providing high-definition motion picture film images. Specifically, the present invention provides a sprocketless highdefinition Photographic Image Registration system and methods for scanning images using such devices.

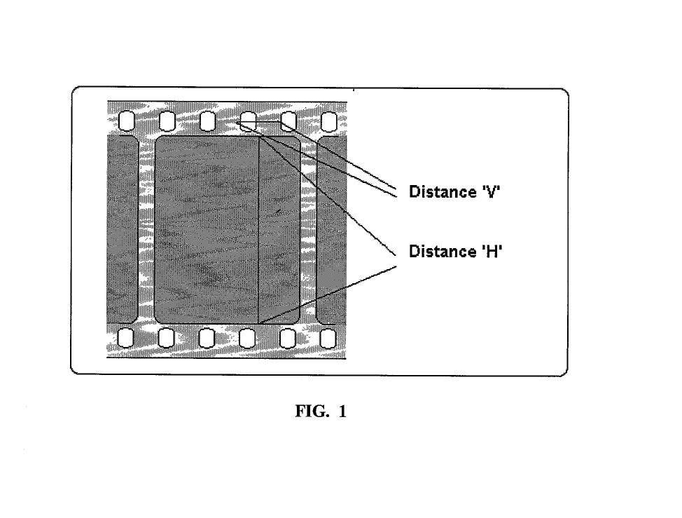

In one embodiment, the present invention describes a system applicable to 35 mm film frame, the principal film format in motion picture today. As shown in FIG. 1, a typical 35 mm film frame has four perforations per image. However, the present invention is equally applicable to other film formats.

In a particular embodiment, the present invention provides a Photographic Image Registration (PIR) system, comprising an image camera and a high-definition line array camera which has an orthogonal orientation to the image scanner. As shown in FIG. 1, the image camera captures a line of the picture content across the film while the PIR camera captures an image along the film. The imaging camera is arranged to capture the image width “H” to its full resolution. The PIR camera is arranged to capture an image along the approximate center line of the perforations and of a size “V” such that regardless of the film position the image always includes a perforation.

In one embodiment, the image cameras include pixels or photo-sensitive elements. Each horizontal line of the image is divided into a number of pixels that can range in number from hundreds to thousands or more. A basic resolution of 2 K (e.g., 2,048) pixels could be used. The vertical size of the image is built up from a number of lines and depends on the aspect ratio of the picture. It is not intended that the present invention be limited to a specific number of lines. In one embodiment, the vertical size of the image may be built from approximately 1,800 lines, such as those used in “cinemascope” squeezed versions. In another embodiment, the vertical size of the image may be built from approximately 1,536 lines, such as those used in “academy” versions. Other sizes for other formats may be used for different applications.

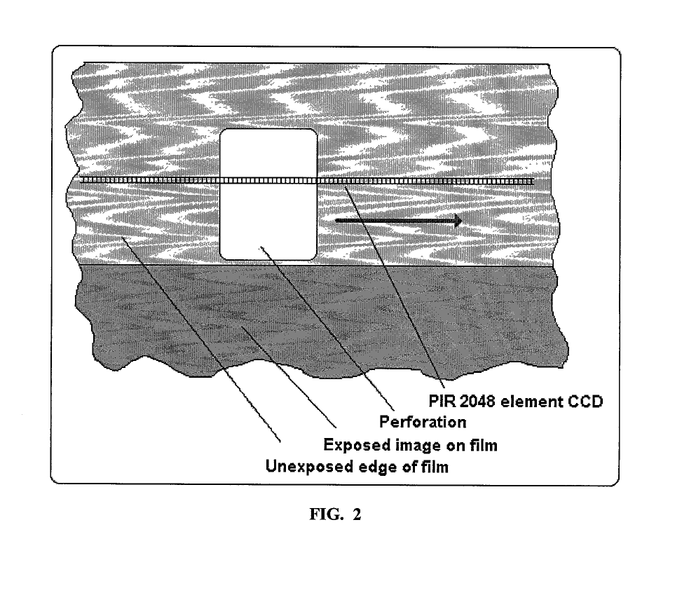

FIG. 2 shows an expanded section of the image of the edge of the film, the perforation, and the exposed area all moving with respect to the CCD in the PIR line array camera. In one embodiment, the CCD is diagrammed as a number of square photo-sensitive pixels. As shown in FIG. 2, the CCD acts as if it were, in effect, an extremely precise electronic ‘ruler’ which, with suitable perforation detection circuitry, can measure the linear progress of the film to the accuracy of one part in 2,048 of the perforation-to-erforation distance. The PIR camera could take more than 45,000 pictures/sec of the edge of the film, equivalent to once every 22 μS (microseconds). Each image is then processed to measure the position of the perforation which is simply a count of the pixels from one end of the CCD to the edge of the perforation. This completely static system is an absolute measurement system of extreme precision with an accuracy of 0.1 of a thousandth of an inch. It has no need for any additional phased lock loop or resolution enhancing electronic circuits to provide this degree of precision.

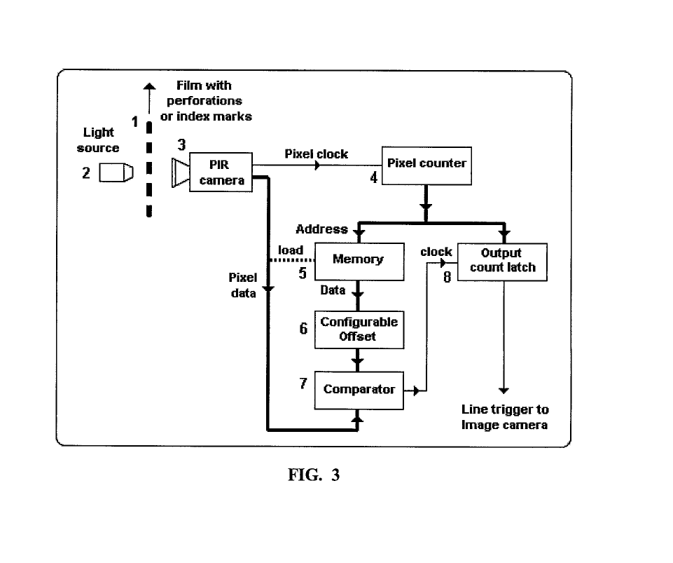

FIG. 3 describes one embodiment of the perforation detection system works. Film and perforations 1 are illuminated by a light source 2, and viewed by a line array camera 3 with the image being acquired along the line of perforations. Initially, the PIR camera is calibrated without any film present by loading the digital signal generated at each pixel position into memory 5 addressed by the pixel counter 4. This calibration normalizes any variation in illumination intensity along the CCD so that the light level for “no film” is known for each pixel. Film in the light path must reduce the amount of light seen in comparison to the ‘no film’ situation.

In one embodiment, a PIR exposure is made every 22 μS. However, it is not intended that the present invention be limited to the number of exposures made. While the next photographic exposure is being made, each of the 2,048 numbers, representing the signal level each pixel attained during the previous exposure, is clocked out of the camera 3. The signal level is then compared in a comparator 7 with the corresponding “no film” value in memory, modified by subtracting a configurable offset 6. This allows a threshold to be set to allow for drift in the actual white level seen by the camera. If the difference between memory (less offset) and the camera signal is less than zero, then the PIR camera has seen “no film” which indicates that a perforation is present. If the difference is greater than zero, then film is present. As soon as the comparator detects a perforation, the pixel count is clocked into the output latch 8. The pixel count clocked into the output latch represents the position of the leading edge of the perforation for that exposure of the PIR camera. After some interval (e.g., 22 μS), the process is repeated and a new position for the leading edge of the perforation is clocked into the output latch.

In one embodiment, the present invention results in a 4:1 improvement in resolution of the PIR camera with respect to the image capture camera. In this embodiment, the trigger for the image camera is simply taken from the second lowest bit of the PIR pixel count. The optical magnification of the lens of the PIR camera is adjusted so that four pixels of its CCD correspond to one line of the image camera. Thus, the PIR pixel counter that keeps track of the position of the perforation will give a trigger pulse to the imaging camera every time a fourth pixel is crossed. In other words, as the edge of the perforation passes each fourth pixel of the PIR camera, a trigger is generated. In one embodiment, the hardware updates the PIR pixel counter every 22 μS. Each line of the image camera will be triggered at nominally 100 μS±11 μS. This is a line accuracy or image stability of ±11% of a line, which on an image comprising 1500 lines is indiscernible.

The PIR camera may be placed anywhere in the film path. In a particular embodiment, the PIR camera is placed at the same place that the image is being acquired. This placement gives the least offset between the point of measurement of the progress of the film and the point at which the image is being captured, thereby resulting in better accuracy. This placement also ensures that any stretch or shrinkage or vibration of the film is eliminated by the PIR being located at the point of image capture.

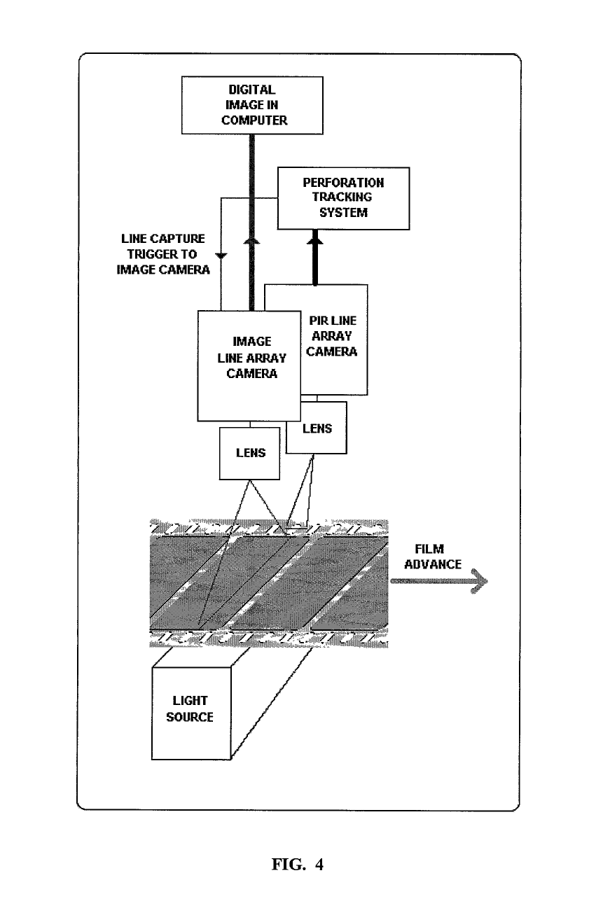

Moreover, the PIR system does not require a physical perforation at all but could be used to track the frame line between images or an index mark on the film. In one embodiment, the apparatus of the present invention scans the registration mark identifying each record on 16 mm wide microfiche or microfilm data. FIG. 4 shows a block diagram of a PIR over a view of the film.

The present invention provides various advantages over prior art systems. Stable images are obtained without using sprocket-based systems to synchronize film advance with scanned images. Unlike prior art systems, the present invention utilizes electronic cameras which perform fast enough or with adequate resolution for the system to work as an absolute measurement system. Prior art scanners based on single photo-detection systems detect only the edge of each perforation generated by the shadow of the film edge passing the photocell, rather than an image of the film and perforation created in a camera. The photocell generates a signal only once every perforation, thereby making it necessary to multiply up the frequency of the perforations to the line frequency of the camera using an oscillator phase locked to the signal from the perforation detector. As a result, these prior art scanners did not perform significantly better than sprocket/encoder systems.

In contrast to single photo-detection and sprocket/encoder systems, the present invention provides an apparatus and method for producing a digital resolution of an image that is higher than the required image scan itself, using the photographic image of the marker, such as the perforation. No interpolation or resolution enhancing techniques are required. The perforation edge is tracked as it progresses down the line array CCD scanner, just like counting cross-ties covered by a train as it travels along a railroad.

It is understood that the examples and embodiments described herein are for illustrative purposes only and that various modifications or changes in light thereof will be suggested to persons skilled in the art, and are to be included within the spirit and purview of this application. It is also understood that the examples containing specific numbers and resolutions are merely illustrative of the present invention, and could be scaled appropriately as required by different applications, particularly in view of technological advances. All publications and patents cited herein are incorporated herein by reference in their entirety for all purposes.

We claim:

1. A film scanner, comprising:
(a) a first image sensor for scanning an image from a film, thereby producing a scanned image;
(b) a second image sensor for capturing an image of a marker along the length of the same film, thereby producing a captured marker image used to trigger said first image sensor;d
(c) means for processing said captured marker image; and
(d) means for synchronizing said first image sensor with said second image sensor.

2. The film scanner according to claim 1, wherein said first image sensor comprises a charge coupled device (CCD) line array scanner.

3. The film scanner according to claim 1, wherein said second image sensor comprises a CCD line array scanner.

4. The film scanner according to claim 1, wherein said first and second image sensors comprise a CCD line array scanner.

5. The film scanner according to claim 1, wherein said second image sensor is placed at an orthogonal orientation to said first image sensor.

6. The film scanner according to claim 1, wherein said second image sensor is placed at the same location as said first image sensor.

7. The film scanner according to claim 1, wherein said marker along said film comprises a perforation.

8. The film scanner according to claim 1, wherein said marker along said film comprises a registration mark opposite an image on said film.

9. The film scanner according to claim 8, wherein said film is 16 mm wide microfiche or microfilm.

10. The film scanner according to claim 1, wherein said marker along said film comprises a frame line between a first and a second image on said film.

11. The film scanner according to claim 1, wherein said means for processing said captured marker image comprises:
(a) means for counting horizontal divisions in said captured marker image that differ from a threshold light level;
(b) means for storing horizontal divisions at an actual light level;
(c) means for accounting an offset between said first image sensor and said second image sensor; and
(d) means for comparing horizontal divisions at said actual light level with horizontal divisions at said threshold light level.

12. The film scanner according to claim 1, wherein said means for synchronizing said first image sensor with said second image sensor comprises:
(a) means for transmitting the position of horizontal divisions in said captured marker image to said first image sensor; and
(b) means for triggering said first image sensor when said horizontal divisions in said captured marker image reach a certain position within said second image sensor.

13. The film scanner according to claim 1, wherein said first image sensor comprises a resolution of approximately 2000 pixels.

14. The film scanner according to claim 12, wherein said second image sensor is configured such that about four pixels of said second image sensor correspond to one line of said first image sensor.

15. A method for scanning an image from a film, comprising:
(a) scanning an image from a film with a first image sensor to produce a scanned image;
(b) capturing an image of a marker along the film with a second image sensor, to produce a captured marker image;
(c) processing said captured marker image; and
(d) synchronizing said first image sensor with said second image sensor.

16. The method according to claim 15, wherein said first image sensor comprises a CCD line array scanner.

17. The method according to claim 15, wherein said second image sensor comprises a CCD line array scanner.

18. The method according to claim 15, wherein said first and second image sensors comprise a CCD line array scanner.

19. The method according to claim 15, wherein said second image sensor is placed at an orthogonal orientation to said first image sensor.

20. The method according to claim 15, wherein said second image sensor is placed at the same location as said first image sensor.

21. The method according to claim 15, wherein said marker along said film comprises a perforation.

22. The method according to claim 15, wherein said marker along said film comprises a registration mark opposite an image on said film.

23. The method according to claim 22, wherein said film is 16 mm wide microfiche or microfilm.

24. The method according to claim 15, wherein said marker along said film comprises a frame line between a first and a second image on said film.

25. The method according to claim 15, wherein said first image sensor comprises a resolution of approximately 2000 pixels.

26. The method according to claim 25, wherein said second image sensor is configured such that about four pixels of said second image sensor correspond to one line of said first image sensor.

27. The method according to claim 15, wherein said processing step further comprises the steps of:
(a) calibrating said second image sensor with a threshold light level;
(b) counting the number of horizontal divisions in said captured marker image that differ from said threshold light level;
(c) storing horizontal divisions at an actual light level;
(d) accounting for an offset between said first image sensor and said second image sensor; and
(e) comparing said horizontal divisions at said actual light level with horizontal divisions at said threshold light level.

28. The method according to claim 15, wherein said synchronizing step further comprises:
(a) transmitting the position of said horizontal divisions in said captured marker image to said first image sensor; and
(b) triggering said first image sensor when said horizontal divisions in said captured marker image reach a certain position within said image sensor.
